(19) United States
(12) Patent Application Publication
(10) Pub. No.: US 2015/0165246 A1
(43) Pub. Date: Jun. 18, 2015

(54) HIP PAD WITH OFFSET ANGLE

(71) Applicant: 3M INNOVATIVE PROPERTIES COMPANY, St. Paul, MN (US)

(72) Inventors: Travis P. Betcher, Goodhue, MN (US); Silvia G.B. Guttmann, St. Paul, MN (US); Emily A. Mursu, Plymouth, MN (US)

(73) Assignee: 3M INNOVATIVE PROPERTIES COMPANY, St. Paul, MN (US)

(21) Appl. No.: 14/108,566

(22) Filed: Dec. 17, 2013

(51) Int. Cl. A62B 35/00

(52) U.S. Cl. CPC A62B 35/0025

(57) ABSTRACT

A hip pad for a safety harness, including a sagittal portion with a sagittal portion belt guide, a right portion with a right portion belt guide, and a left portion with a left portion belt guide. The right portion belt guide and left portion belt guides are oriented at an offset angle from the sagittal portion belt guide.

### BACKGROUND

Safety harnesses are often used e.g. to provide fall protection for workers in industrial settings, construction sites, and so on.

### SUMMARY

In broad summary, herein is disclosed a hip pad for a safety harness, the hip pad comprising a sagittal portion with a sagittal portion belt guide, a right portion with a right portion belt guide, and a left portion with a left portion belt guide. The right portion belt guide and left portion belt guides are oriented at an offset angle from the sagittal portion belt guide. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a perspective view of the rear side of an exemplary hip pad as disclosed herein.

FIG. 2 is an exploded perspective view of the exemplary hip pad of FIG. 1.

FIG. 3 is a plan view of the rear side of the exemplary hip pad of FIG. 1.

FIG. 4 is a plan view of the front side of the exemplary hip pad of FIG. 1.

FIG. 5 is a schematic cross-sectional view of a portion of an exemplary hip pad as disclosed herein.

FIG. 6 is a plan view of the rear side of the exemplary hip pad of FIG. 1.

FIG. 7 is a perspective view from the rear side, showing an exemplary hip pad fitted to a hip belt of a safety harness worn by a user.

FIG. 8 is a perspective view from the rear side, showing an exemplary hip pad along with portions of other components of a safety harness to which the hip pad is fitted.

FIG. 9 shows various planes and reference directions with respect to human anatomy.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Terms of geometry and spatial relationship used herein are applied when the herein-disclosed hip belt and other components of a safety harness are fitted to (worn by) a user, unless otherwise noted. Terms such as right, left, top, bottom, upward, downward, and so on, have their customary meaning as applied from the perspective of a person wearing the safety harness. Vertical means a direction parallel to the line provided by the intersection of the sagittal and coronal planes of a human body. The sagittal (medial), transverse, coronal, transtubercular and transpyloric planes have their customary meaning in relation to human anatomy. (For reference, various planes and directions with regard to human anatomy are shown in FIG. 9.) Inward means toward the line provided by the intersection of the sagittal and coronal planes of a human body, outward means away from such a line (the terms inward and outward are thus defined relative to the body of a person wearing the safety harness, with the exception of the specific terms radially-inward and radially-outward, as noted later herein). Terms such as front and forward refer to directions toward the anterior side of a human body, terms such as rear and back refer to directions away from the anterior side of a human body. The term thickness refers to the shortest dimension through an item. As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

### DETAILED DESCRIPTION

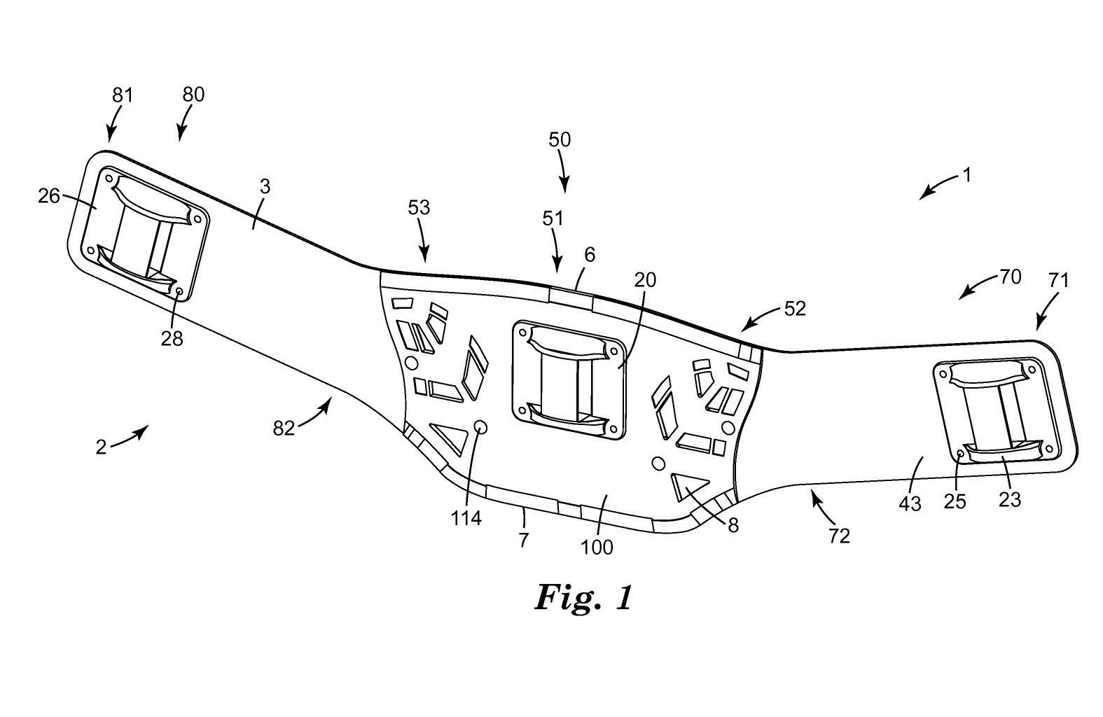

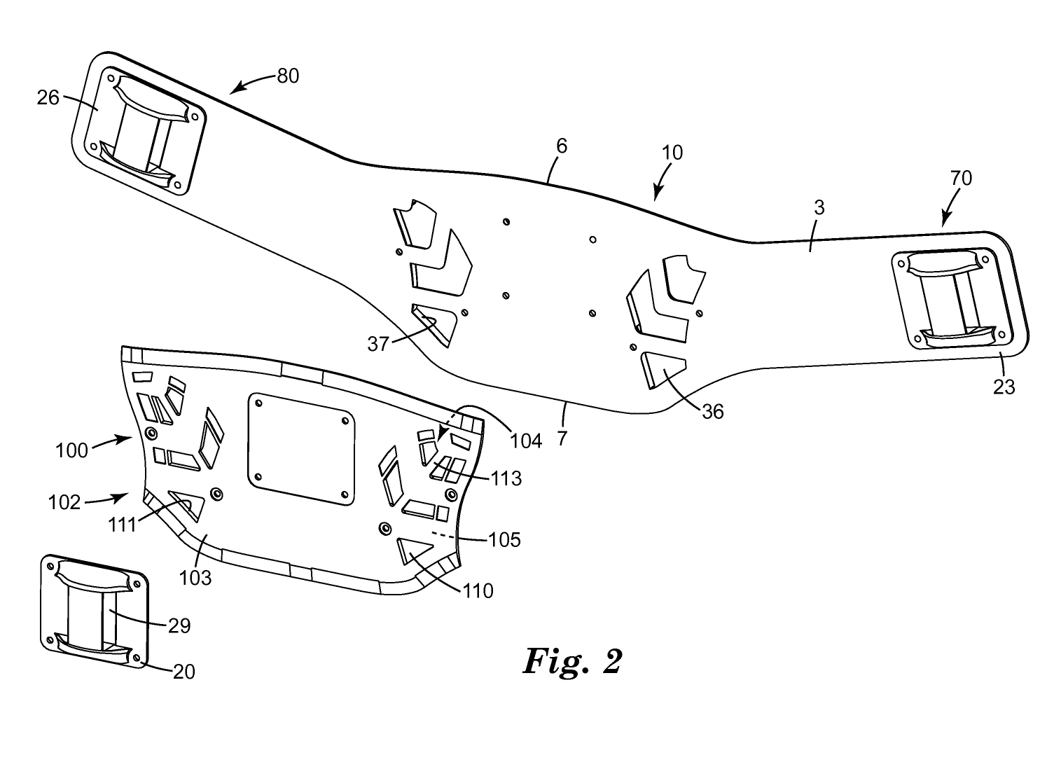

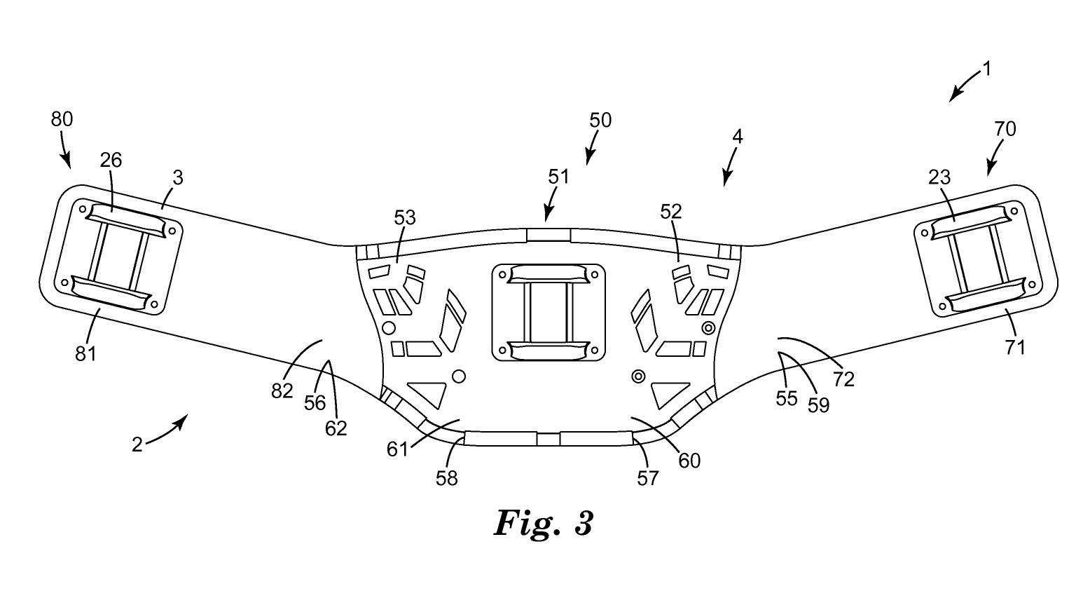

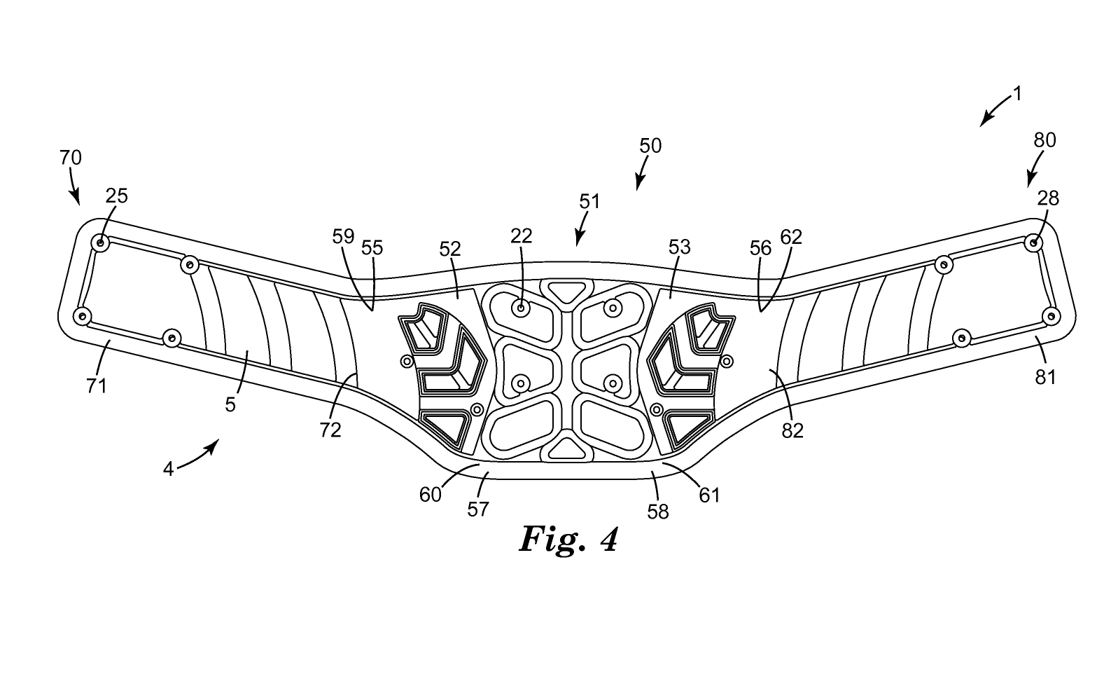

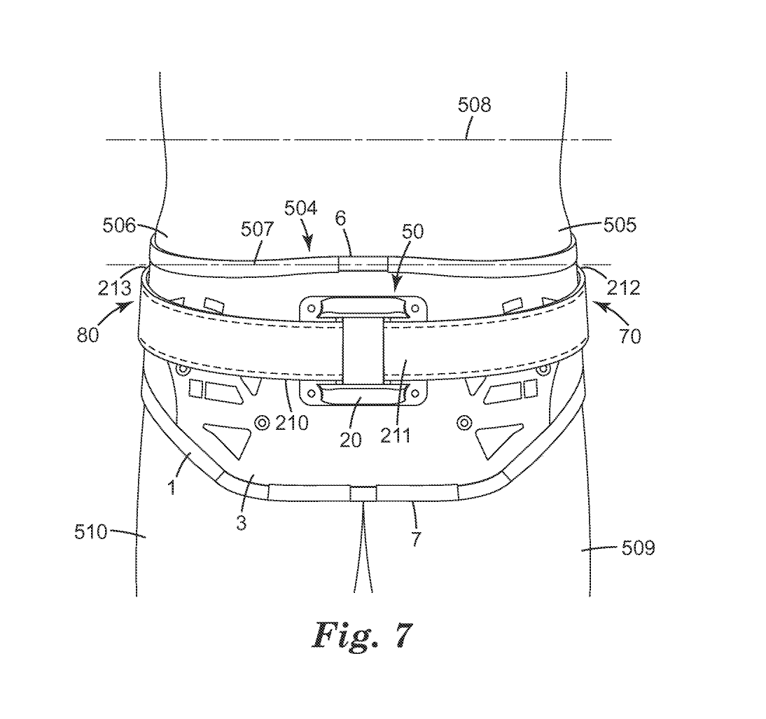

Disclosed herein is a hip pad for use with a fall-protection safety harness. An exemplary hip pad 1 is shown in perspective view from the rear in FIG. 1, in exploded perspective view from the rear in FIG. 2, in plan view from the rear in FIG. 3, and in plan view from the front in FIG. 4. As shown in FIG. 7 in exemplary manner and as discussed in detail later herein, hip pad 1 is configured to be fitted to a hip belt 210 of a safety harness. Hip pad 1 comprises a sagittal portion 50 with a sagittal portion belt guide 20 mounted thereon, which sagittal portion belt guide 20 is configured to accept a sagittal section 211 of hip belt 210 therethrough. By sagittal portion is meant a portion of pad 1 that, when the safety harness is worn by a user, is intersected by the sagittal plane 501 of the user, as discussed in further detail later herein. Hip pad 1 also comprises a right portion 70 that extends integrally from sagittal portion 50 and that comprises a right portion belt guide 23 mounted thereon, which right portion belt guide 23 is configured to accept a right section 212 of hip belt 210 therethrough; and, a left portion 80 that extends integrally from sagittal portion 50 (e.g., in a direction at least generally opposite from right portion 70) and that comprises a left portion belt guide 26 mounted thereon, which left portion belt guide 26 is configured to accept a left section 213 of hip belt 210 therethrough. Any such belt guides may be conveniently provided on the outward side of hip pad 1 (e.g. mounted on an outward surface of hip pad 1) so that hip pad 1 may provide a cushioning function between hip belt 210 and a user's body.

In many embodiments, right portion 70 and left portion 80 may be symmetrical with each other in shape and size, as in the exemplary embodiments depicted in the Figures herein. As most easily seen in FIG. 3, in some embodiments right portion 70 may take the form of a right elongate arm with a proximal end 72 that is integrally attached to a right end 55 of sagittal portion 50 and with a distal end 71 having right portion belt guide 23 mounted thereon. Similarly, left portion 80 may take the form of a left elongate arm with a proximal end 82 that is integrally attached to a left end 62 of sagittal portion 50 and with a distal end 81 having left portion belt guide 26 mounted thereon. It will be understood that by a “distal end” of a right or left portion of hip pad 1 is meant the general area within a few (e.g., 10, 6, 4 or 2) centimeters of the terminal (leftmost or rightmost) edge of such a portion; the word “end” is not limited to denoting only the terminal edge itself. Thus, the mounting of a belt guide to a distal end of a portion merely requires that the guide be mounted at a location proximate the end, rather than the guide necessarily being at the terminal edge of the pad or extending past the terminal edge of the pad. In fact, in specific embodiments, no portion of right or left belt guides 23 or 26 extends past a respective right or left terminal edge of hip pad 1. It will also be understood that by a proximal end of a right or left portion of pad 1, and a corresponding right or left end of sagittal portion 50 (from which right or left end of sagittal portion 50 the right or left portion respectively extends), is not necessarily meant any physical edge or terminus. Rather, in some embodiments such ends will each “terminate” at an imaginary line (running at least generally vertically between upper edge 6 and lower edge 7 of pad 1) that demarcates the boundary between the sagittal portion of 1 and the right or left portion of pad 1.

In some embodiments, sagittal portion 50 may comprise a central region 51 (most easily seen in FIG. 3). In some embodiments, central region 51 may comprise a vertical (upward-downward in FIG. 3) width that is at least generally (often, substantially) constant along the longitudinal (left-right in FIG. 3) extent of central region 51. In some embodiments, sagittal portion 50 may further comprise a right region 52 that extends integrally from central region 51 and that comprises a left end 60 that integrally abuts a right end 57 of central region 51 and that comprises a right end 59 that provides right end 55 of sagittal portion 50. Sagittal portion 50 may similarly comprise a left region 53 that extends integrally from central region 51 (e.g., in a direction at least generally opposite from right region 52) and that comprises a right end 61 that integrally abuts a left end 58 of central region 51 and that comprises a left end 62 that provides left end 56 of sagittal portion 50. (Again, such ends will may terminate at imaginary lines that demarcate boundaries between the various regions rather than at any specific physical edge.)

In some embodiments, right region 52 may taper in generally vertical width so that a generally vertical width of right end 59 of right region 52 is less than a generally vertical width of left end 60 of right region 52 by at least about 15%. (The term generally vertical width is used in view of the fact that the width of such regions may be conveniently measured along the shortest path between upper and lower edges of pad 1 at that location, rather than being limited to measurements taken strictly parallel to a vertical axis. In further embodiments, the generally vertical width of right end 59 of right region 52 may be less than the generally vertical width of left end 60 of right region 52 by at least about 20, 30, or 40%. Similarly, in some embodiments, left region 53 may taper in generally vertical width so that a generally vertical width of left end 62 of left region 53 is less than a generally vertical width of right end 61 of left region 53, by at least about 15, 20, 30, or 40%.

In some embodiments, right region 52 may comprise at least one vent opening 8 that extends through hip pad 1 (that is, through the entire thickness of pad 1, so as to allow airflow therethrough) and that is not occluded (blocked) by hip belt 210 when hip pad 1 is fitted to hip belt 210. (Such an arrangement can be seen in exemplary embodiment in FIG. 7). Similarly, in such embodiments left region 53 may comprise at least one vent opening that extends through hip pad 1 and that is not occluded by hip belt 210 when hip pad 1 is fitted to hip belt 210. In some embodiments, a plurality of vent openings may be provided in right and left vented regions 52 and/or 53, as discussed in detail later herein.

Hip pad 1 may be of any suitable construction. In some embodiments, hip pad 1 may comprise multiple portions (e.g., central, right and left portions; each of which may comprise e.g. outer canvas layers that sandwich a resilient polymer foam (e.g., a non-thermoformed foam) inner layer therebetween) that are non-integral portions that are joined to each other at their respective edges (e.g. by sewing) to form hip pad 1. In other embodiments, hip pad 1 may comprise a single (e.g., integral) portion that comprises e.g. outer canvas layers that sandwich a resilient polymer foam (e.g., a non-thermoformed foam) inner layer therebetween.

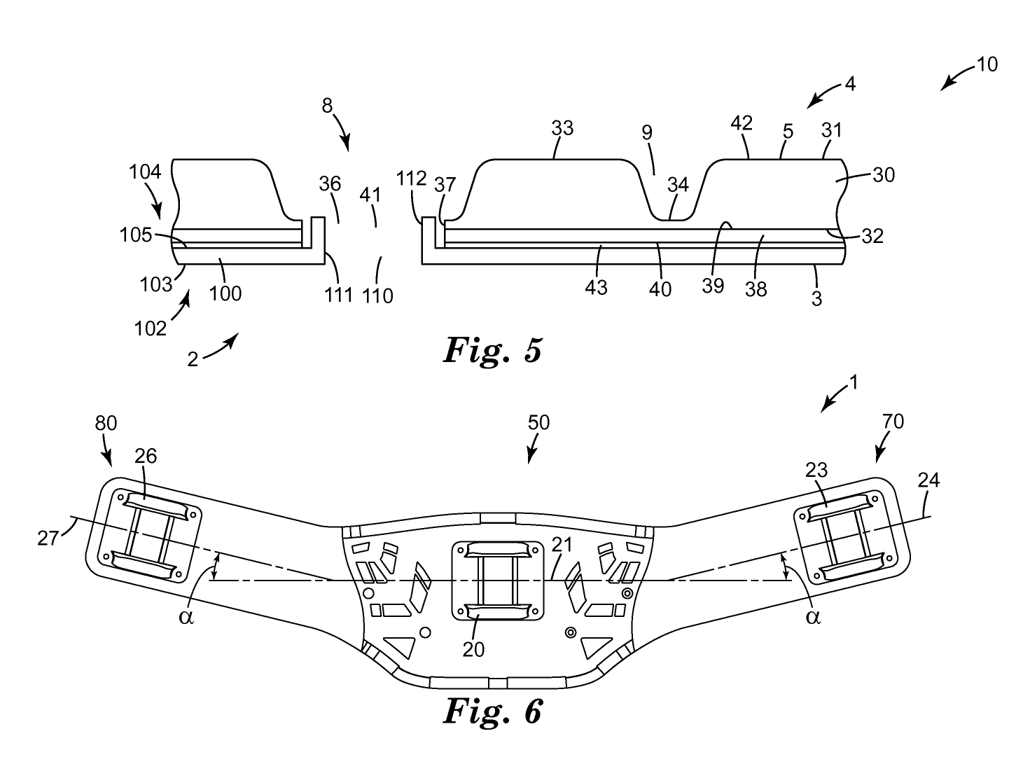

In some embodiments, main body 10 of hip pad 1 may comprise a first core layer 30 (seen e.g. in the cross-sectional view of FIG. 5) that is an integral layer of thermoformed resilient organic polymer foam and that integrally extends through sagittal portion 50 and right and left portions 70 and 80 of main body 10 of hip pad 1. By integrally extends through right and left potions 70 and 80 is meant that core layer 30 extends continuously from distal end 71 of right portion 70 to distal end 81 of left portion 80 (although through-holes may be interspersed in core layer 30 as described later herein). That is, any such through-holes are bounded (i.e., no single through-hole extends to both upper edge 6 and lower edge 7 of hip pad 1) so that a continuous path (that is, an uninterrupted path, although not required to be a straight line) may be traced along core layer 30 along from right distal end 71 to left distal end 81.

First core layer 30 may be comprised of e.g. a resilient organic polymer foam configured to provide a cushioning effect. Core layer 30 may be thermoformed; i.e., placed into a mold and shaped under heat and pressure so as to permanently deform one or more depressions 34 into core layer 30. The thermoforming process can thus impart a stable pattern of plateaus 33 (which may often correspond at least generally to the original thickness of layer 30 prior to the thermoforming process), and depressions 34, as shown in generic representation in FIG. 5. such depressions 34 may conveniently provide vent channels 9 which can allow air flow e.g. toward an edge and/or toward a vent opening 8, of hip pad 1. Thus, in some embodiments the front (inwardmost) surface 5 of at least central region 51 of sagittal portion 50 may comprise a plurality of thermoformed vent channels 9, which vent channels may extend at least generally along a major plane of central region 51, at least some of which vent channels 9 may be in fluid communication with an upper edge 6 or a lower edge 7 of the sagittal portion 50. In some embodiments, at least one such vent channel 9 may be in fluid communication with at least one vent opening 8 of sagittal portion 50 of hip pad 1. Arrangements of both these types are seen in exemplary embodiment in FIG. 4.

First core layer 30 may be comprised of any suitable resilient organic polymer foam that is suitably thermoformable. In specific embodiments, first core layer 30 may be comprised of an ethylene-vinyl acetate copolymer foam. In some embodiments, first core layer 30 may exhibit a density of from about 0.5 to about 8, about 1 to about 4, or about 1.5 to about 2.5, pounds per cubic foot (prior to any thermoforming).

In some embodiments, main body 10 of hip pad 1 may comprise a second core layer 38 that is positioned outward from first core layer 30 (as shown in FIG. 5). Second core layer 38 may likewise be an integral layer of organic polymer foam that integrally extends through sagittal portion 50 and the right and left portions 70 and 80 of main body 10 of hip pad 1. In some embodiments, second core layer 38 may be at least generally, substantially, or strictly coterminous (i.e., the same size and shape, and sharing borders in common) with first core layer 30. In some embodiments second core layer 38 may be made of an organic polymer foam that is not readily thermoformable (or, a thermoforming process may be carried out so that second core layer 38, even if thermoformable, is relatively unaffected by the thermoforming process). Thus, in some embodiments, substantially all uncompressed areas (meaning areas not compressed e.g. by the pressure of a rivet) of second core layer 38 in hip pad 1 may comprise a thickness that is at least about 80% of the unthermoformed thickness of the second core layer material (i.e., the thickness of the second core layer material prior to any thermoforming being carried out). In some embodiments, the thickness of substantially all uncompressed areas of second core layer 38 in pad 1 may be at least substantially identical to the thickness of layer 38 prior to any thermoforming.

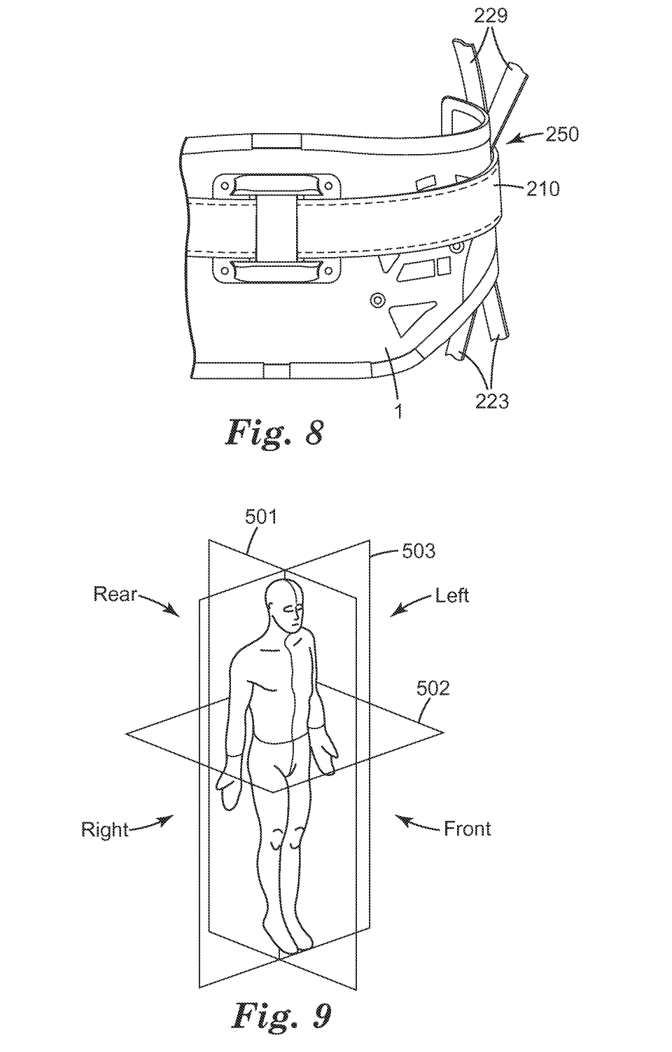

Second core layer 38 is placed outward of first core layer 30 and may provide useful stiffening and/or structural integrity to main body 10 of hip pad 1. As such, second core layer 38 may need only to be conformal (i.e., able to be bent or curved sufficiently to allow hip pad 1 to be curved around a user's hips as shown in FIGS. 7 and 8). That is, second core layer 38 may not necessarily need to be resilient in the manner of first core layer 30, since second core layer 38 may not need to provide any significant cushioning effect. Accordingly, in some embodiments second core layer 38 may be comprised of e.g. an organic polymer foam (of similar, or different, composition from the organic polymer foam of first core layer 30) with a density that is greater than the density of the organic polymer foam of first core layer 30 by a factor of at least two, three, four, five, or six. In some embodiments, first core layer 30 may exhibit a density of from about 6 to about 18, about 8 to about 16, or about 10 to about 14, pounds per cubic foot (prior to any thermoforming).

If desired, second core layer 38 may comprise a thickness that is significantly less than that of the thickest (after thermoforming) areas of first core layer 30. Such an arrangement can provide the desired structural integrity while retaining sufficient conformability to allow hip pad 1 to be wrapped around a user's hip area. In various embodiments, the average thickness of second core layer 38 may be no more than about 20, 15, 10, or 5% of the average thickness of the thickest areas (plateaus) 34 areas of first core layer 30. Second core layer 38 may be conveniently incorporated into main body 10 of pad 1 by way of being placed into a thermoforming mold along with first core layer 30 with a layer of adhesive (e.g., heat-activated adhesive) therebetween. The thermoforming process can thus also accomplish bonding so that second core layer 38 comprises a inward-facing major surface 39 that is adhesively bonded to a outward-facing major surface 32 of first core layer 30 as shown in FIG. 5. In some embodiments, the bonding process may be such that first and second core layers 30 and 38 may not be physically separable from each other after the thermoforming/bonding process.

In some embodiments, main body 10 of hip pad 1 may comprise an inwardmost surface layer 42 that is a stretchable fabric that is positioned inwardly of first core layer 30 and that is thermoformed therewith. Such a surface layer 42 thus may comprise a first, outward-facing major surface that is e.g. adhesively bonded to an inward-facing major surface 31 of first core layer 30, and a second major surface that provides inwardmost surface 5 of hip pad 1. Any suitable fabric may be used that is able to be satisfactorily thermoformed and that does not unacceptably interfere with the cushioning effect of first core layer 30. For example, a stretchable woven, knitted, or nonwoven fabric may be used. In some embodiments, such a stretchable fabric may be highly stretchable (e.g., with an elongation at break of greater than 200, 400, or 600%).

In some embodiments, main body 10 of hip pad 1 may comprise an outward surface layer 43 that may be comprised of filaments of e.g. at least about 100 denier. In various embodiments, filaments of layer 43 may be at least about 200, 400, or 600 denier. Layer 43 may be positioned outwardly of second core layer 38 and may provide outwardmost surface 3 of hip pad 1 (in areas where layer 43 is not outwardly covered by protective plate 100, which is described later herein). In some embodiments layer 43 may be e.g. a non-stretchable fabric (meaning it exhibits an elongation at break of less than about 20%) that may provide e.g. improved abrasion resistance, tear strength, structural integrity, and so on. Layer 43 may comprise a first, inward-facing major surface that is adhesively bonded to an outward-facing major surface 40 of second core layer 38, and a second major surface that provides at least a portion of an outwardmost most surface 3 of hip pad 1.

Based on these discussions of the components of main body 10 and the manner in which main body 10 of hip pad may be formed, it can now be appreciated that language used herein such as integrally extend, integrally attach, integrally abut, etc., reflects the fact that in some embodiments, substantially the entire length of the main body 10 of hip pad 1 (excepting e.g. any edge-guard fabric that might be e.g. wrapped around terminal edges of the main body 10 of hip pad 1), including the above-described portions and regions, may be formed of a single structure (although such a structure may comprise multiple layers as discussed above), e.g. by a thermoforming/adhesive bonding operation. In such embodiments, the different portions and regions are integrally connected to each other (that is, are portions and regions of a single integral structure) and are chiefly distinguishable from each other by their locations and/or by geometric features (shape, width, etc.). Such an integral structure may be contrasted with a hip pad in which e.g. different portions are provided separately and are then attached (e.g., by sewing or by some other joining mechanism) to each other.

In some embodiments, main body 10 of hip pad 1 thus may comprise inward surface layer 42 and first core layer 30 (both of which may often be significantly thermoformed); and, second core layer 38 and outward surface layer 43 (both of which may often be thermoformed to little or no extent), as depicted in exemplary embodiment in FIG. 5. All of these layers may comprise through-holes therethrough (e.g., through-holes 36 in first core layer 30 and through-holes 41 in second core layer 38, as well as corresponding through-holes in layers 42 and 43). The through-holes in the various layers may be aligned (as shown in FIG. 5) so as to provide through-holes that extend through the entire thickness of main body 10 of hip pad 1 to provide a vent opening 8. Such aligned through-holes may be conveniently achieved e.g. by die-cutting (if desired, areas of first core layer 30 that are to be die cut may be thermoformed to make them much thinner, so as to facilitate die cutting). Such die-cutting (or any suitable method of cutting, e.g. laser-cutting, water-jet cutting, etc.) might ordinarily leave edges 37 in first core layer 30 (as well as corresponding edges of the other layers) that are exposed. If desired, such otherwise-exposed edges may be protected by flanges 112 of a protective plate 100, as discussed below. If desired, a canvas (or any other suitable construction) fabric may be wrapped around the edges of some or all of the perimeter of main body 10, to provide extra protection for such edges. Such a protective edge wrap (not shown in any Figure) may be e.g. sewn in place, adhesively bonded, etc., as desired.

In some embodiments, hip pad 1 may comprise a molded flexible organic polymer protective plate 100 that may be attached to a portion of main body 10 as shown e.g. in FIGS. 1 and 2. Protective plate 100 may provide additional stiffening, abrasion resistance, and so on, to the outwardmost (rear) side of sagittal portion 50 of hip pad 1. In various embodiments, protective plate 100 may at least substantially outwardly cover the central region 51 of sagittal portion 50 of hip pad 1. (By substantially is meant that plate 100 may not necessarily reach to the very upper and lower edges of central region (which edges may be wrapped e.g. in a protective canvas as mentioned above)). In further embodiments, plate 100 may further outwardly cover at least a portion of right region 52 of sagittal portion 50 and of left region 53 of sagittal portion 50, as shown in exemplary embodiment in FIGS. 1 and 3.

In some embodiments, protective plate 100 may comprise a plurality of through-holes 110 that at least generally align with (overlap) a plurality of through-holes in the other layers so as to provide a plurality of vent openings 8. In some embodiments, such vent openings 8 may be provided in right vented region 52 and in left vented region 53 of sagittal portion 50, but not in central region 51 of sagittal portion 50 of hip pad 1. In specific embodiments, vent openings 8 may make up from about 10% to about 40%, or from about 20% to about 30%, of the area of a right vented region 52 and/or the area of a left vented region 53. Unlike the through-holes in the other layers (which through-holes may often share borders if derived e.g. from a common die-cutting process), through-holes 110 of protective plate 100 may not necessarily be coterminous with the through-holes of the other layer. For example, in the exemplary embodiment of FIG. 2, selected through-holes 110 each comprise a strut 113 that covers a portion of a through-hole that extends through the other layers. Such struts may add mechanical integrity as desired, without unacceptably detracting from the venting provided by such through-holes.

In some embodiments, edges 111 of protective plate 100 that define a through-hole 110 therethrough, may be located radially inwardly (meaning toward the geometric center of through-hole 110) to a greater extent than corresponding edges (e.g. edge 37 of a through-hole in first core layer 30) of corresponding through-holes in the other layers. Such an arrangement, which is shown in exemplary embodiment in FIG. 5, can provide that the narrowest portion of each vent opening 8 is provided by an edge 111 of protective plate 100 rather than by an edge of some other layer. This can provide protection to e.g. edges 37 of first core layer 30. To enhance this protection, if desired a flange 112 can be provided that extends inwardly (toward the user's body) so as to radially inwardly abut at least edge 37 of through-hole 36 in first core layer 30. (Such a flange can also radially inwardly abut a corresponding through-hole 41 in second core layer 38, and a corresponding through-hole in outward surface layer 43, as in the exemplary embodiment of FIG. 5). In such a case, at least the edge 37 of a through-hole 36 in first core layer 30 is radially inwardly bounded by flange 112, which may advantageously provide protection from e.g. abrasion, damage, etc., for e.g. otherwise-exposed edges 37 of first core layer 30. Protective plate 100 may be comprised of any suitable moldable organic polymer, e.g. a thermoplastic molding resin, of any suitable average thickness. The properties and thickness of plate 100 may be chosen so that plate 100 provides e.g. protection from damage, and yet is conformal to sufficient extent to allow right and left regions 52 and 53 of sagittal portion 50 to bend sufficiently to allow right and left portions (e.g., arms) 70 and 80 of hip pad to be wrapped around the hips of a user. (The presence of through-holes in plate 100 in right and left vented regions 52 and 53 of sagittal portion 50 of pad 1, as shown in the exemplary embodiment of FIG. 2, may of course enhance the ability of these regions of plate 100 to be conformed.) In specific embodiments, no part of plate 100 extends onto left or right portions 70 and 80.

Protective plate 100 may be attached to main body 10 with inward (front) surface 105 of inward side 104 of plate 100 facing, e.g. in contact with, main body 10, and with outward surface 103 of outward side 102 facing away (with outward surface 103 of plate 100 thus providing outwardmost surface 3 of hip pad 1 in those locations). Such attachment may be by any suitable method, e.g. by the use of two or more rivets 114 that pass through protective plate 100 and through the various layers of main body 10. Pre-formed (e.g., die cut) through holes may be provided in protective plate 100 and/or the layers of main body 10, to facilitate the riveting process. Other methods (e.g., adhesive attachment, ultrasonic bonding, and so on), may be used, either to augment or in place of the use of a mechanical fastening method such as rivets.

Belt Guides

Hip pad 1 may comprise at least three belt guides: a sagittal portion belt guide 20 provided on (e.g., mounted on) sagittal portion 50 of hip pad 1, a right portion belt guide 23 provided on right portion 70 of pad 1, and a left portion belt guide 26 provided on left portion 80 of pad 1, as shown in exemplary embodiment in FIGS. 1-3. Additional belt guides may be used if desired. By belt guide is meant an at least semi-rigid structure (made e.g. of molded plastic, metal, canvas, or a combination thereof) that provides a through-opening that allows a belt to extend therethrough in a direction along the long axis of the belt, but does not allow the belt to be removed along any direction (e.g., outwardly from pad 1) other than possibly along the long axis of the belt (noting that it is not necessarily required that a belt be completely removable from any particular belt guide). In various embodiments, such a through-opening may be provided entirely by the belt guide, or may be provided by the belt guide acting in combination with surfaces of main body 10 and/or protective plate 50 of hip pad 1 (as in designs of the general type exemplified by through-opening 29 as shown in FIG. 2). Such guides thus collectively position hip pad 1 and hip belt 210 in a desired relationship to each other along a desired length of pad 1 and belt 210 (e.g., as pictured in exemplary illustration in FIG. 7).

Each belt guide is provided on a particular portion of hip pad 1. In some embodiments, each belt guide is fixed to the particular portion, meaning that the guide cannot rotate relative to that portion of hip pad 1 around an axis that is at least substantially perpendicular to the major plane of that portion of hip pad 1. (It will be noted however that such a fixed belt guide could be slightly movable in some directions; for example, a fixed belt guide could take the form of e.g. a D-ring with a proximal end that is pivotably attached to hip pad 1 so that the distal end of the D-ring can be moved back and forth to at least a limited extent e.g. in a direction along the long axis of hip pad 1). Such a fixed belt guide may define a belt orientation axis, meaning that the guide establishes a direction that the long axis of the section of the belt passing through the guide must at least substantially align with.

Offset Angles

Thus in some embodiments, hip pad 1 comprises a fixed sagittal portion belt guide 20 that defines a sagittal portion belt orientation axis 21 as shown in FIG. 6, along which axis is oriented sagittal section 211 of hip belt 210 as shown in FIG. 7. Hip pad 1 may be configured so that when safety harness 200 is worn by a user, sagittal portion belt orientation axis 21 is oriented substantially parallel to the transverse plane (plane 502 as shown in FIG. 9) of the body of the user, again as shown in FIG. 7. Hip pad 1 may further comprise a fixed right portion belt guide 23 that defines a right portion belt orientation axis 24 as shown in FIG. 6, along which axis is oriented right section 212 of hip belt 210 as shown in FIG. 7. Hip pad 1 may further comprise a fixed left portion belt guide 26 that defines a left portion belt orientation axis 27 as shown in FIG. 6, along which axis is oriented left section 213 of hip belt 210 as shown in FIG. 7. As shown in exemplary embodiment in FIG. 6, left portion belt guide 26 and/or right portion belt guide 23 may be angled relative to sagittal portion belt guide 20 so that their respective belt orientation axes 27 and 24 exhibit an upwardly offset angle α (alpha) relative to sagittal portion belt orientation axis 21. By upwardly offset is meant that as the distance from the sagittal portion belt guide increases, the upward deviation of the (left or right portion) belt orientation axis 27 or 24 from the sagittal portion belt orientation axis 21 increases (as is evident in FIG. 6). In various embodiments, the upwardly offset angle α established between a right and/or left portion belt guide, and the sagittal portion belt guide, may be at least about 8, 10, 12, 14, 16, or 18 degrees. In further embodiments, the upwardly offset angle α established between a right and/or left portion belt guide, and the sagittal portion belt guide, may be at most about 32, 28, 24, 20, 18, or 16 degrees. (In the exemplary embodiment of FIG. 6, an upwardly offset angle α in the range of approximately 14 degrees is present for both the left and right belt guides). In particular embodiments the design may be symmetrical (as shown in FIG. 6) with the right and left portion belt guides establishing substantially identical offset angles α relative to the sagittal portion belt guide. It will be appreciated that upwardly offset angle α will be measured with hip pad 1 in a planar configuration as shown in FIG. 6 rather than with pad 1 fitted to a (wrapped around) a user's hips as shown in FIG. 7.

Belt guides may be attached to hip pad 1 e.g. by any suitable fastening mechanism (rivets 22, 25 and 28 are used in the exemplary embodiments shown in the Figures herein, but this might be augmented by, or replaced by, e.g. the use of adhesives or the like). In some embodiments, any or all belt guides of hip pad 1 may be attached to pad 1 so that no part of the belt guide is translationally movable relative to pad 1. In some particular embodiments, a right or left portion belt guide may be attached to an end (meaning an area adjacent the terminal edge of that portion of hip pad 1) of a right or left portion of pad 1 so that no part of the belt guide extends past a terminal edge of that portion of pad 1.

In some embodiments, right portion 70 of hip pad 1 may take the form of a right elongate arm (e.g., with a readily discernible long axis, as in e.g. FIGS. 1 and 6) with a proximal end 72 that is integrally attached to a right end 55 of sagittal portion 50 of pad 1 and with a distal end 71 having a right belt guide mounted thereon. Similarly, left portion 80 of hip pad 1 may take the form of left elongate arm with a proximal end 82 that is integrally attached to a left end 56 of sagittal portion 50 and with a distal end 81 having a left belt guide mounted thereon. In such embodiments, right portion 70 and/or left portion 80 may comprise a readily identifiable long axis that exhibits an upwardly offset angle relative to a sagittal portion belt orientation axis 21 (regardless of the particular orientation in which the right and left portion belt guides are mounted on their respective portions of pad 1). In particular embodiments, however, a right elongate arm 70 of pad 1 may exhibit a long axis that is at least substantially aligned with a right portion belt orientation axis 24 that is defined by a right portion belt guide 23; similarly, a left elongate arm 80 of pad 1 may exhibit a long axis that is at least substantially aligned with the left portion belt orientation axis 27 that is defined by a left portion belt guide 26. (Here and elsewhere when referring to angles, the term substantially aligned means within plus or minus 10 degrees). In various embodiments, the length (along their long axis) of right and left portions 70 may be varied, e.g. so as to provide hip pads 1 in various overall sizes. Along with this, or instead of this, the length of sagittal portion 50 may be varied so as to provide hip pads 1 of various overall sizes.

Hip pad 1 is configured to be fitted to a hip belt 210 (meaning at least one hip belt, as discussed in detail later herein) of a fall protection safety harness. When the safety harness is properly fitted to a user, with inward side 4 of pad 1 facing toward the user and with outward side 2 facing away, sagittal region 50 will reside outward from the general gluteal area of the user. Typically, a vertical centerline of sagittal portion 50 of pad 1 will be substantially (often, nearly exactly except for e.g. temporary deviations caused by body movements) aligned with the sagittal plane 501 of the user (as shown in FIG. 7). Right and left portions 70 and 80 of hip pad 1 will respectively wrap arcuately forwardly around at least a part of the right and left hip areas 505 and 506 of the user, again as shown in FIG. 7. Hip pad 1 is thus configured to reside on the hip area of a user. Specifically, hip pad 1 is configured to provide comfort and cushioning for the lower part of the “small” 504 of the user's back, and for the upper part of the gluteal region of the user. As such, hip pad 1 may be distinguished from e.g. various waist belts and the like that are positioned higher along the vertical axis of the user. In some embodiments, hip pad 1 is configured so that all points along upper edge 6 of sagittal portion 50 remain below transpyloric plane 508 of the user (as shown in exemplary embodiment in FIG. 7) when the safety harness is properly fitted to the user. In further embodiments, hip pad 1 is configured so that all points along upper edge 6 of sagittal portion 50 remain substantially even with (i.e., no more than 1 cm above) or below the transtubercular plane 507 of the user when the safety harness is properly fitted to the user. Lower edge 7 of hip pad 1 will often reside near the lower gluteal area, or near the upper portions of right and left legs 509 and 510.

Furthermore, in at least some embodiments hip pad 1 is not a load-bearing component of safety harness 200. By this is meant that in the event of a fall, hip pad 1 does not support a significant amount of the load that results when a wearer's fall is arrested (that function being performed e.g. by various torso and leg straps of harness 200, as described later herein). However, in some embodiments hip pad 1 may be weight-bearing to the extent of supporting at least a portion of the weight of any tools that may be optionally provided in a tool receptacle that may be supported by a hip belt, as discussed below.

Hip pad 1 is configured to be mated to a hip belt. Any suitable hip belt of a safety harness can be used (such belts are often comprised of e.g. heavy canvas or webbing). Such a hip belt is fitted through the above-described belt guides as shown in exemplary manner in FIG. 7. Although only a single exemplary hip belt 210 is depicted in the exemplary illustrations of FIGS. 7 and 8, in many embodiments more than one (e.g., two) hip belts may be used. That is, in some circumstances it may be desired to use an inward hip belt and an outward hip belt, that are inserted through the belt guides in close proximity to each other, e.g. with much of the area of an inward major surface of the outward hip belt closely abutting, or in many cases contacting, much of the area of an outward major surface of the inward hip belt. For example, an inward hip belt might be a non-removable belt (e.g. that has a structure at each terminal end of the belt that physically prevents that terminal end of the belt from being passed through a belt guide), which belt might comprise e.g. one or more D-rings e.g. for positioning of the wearer of the safety harness. Such a belt, while not necessarily being removable from hip pad 1, may be translationally movable relative thereto (along the long axis of the belt) to at least a limited extent. In other embodiments, such an inner belt might be not only non-removable from hip pad 1, it might be non-movably attached thereto (e.g., by sewing).

An outward hip belt may be removable if desired. Whether or not it is removable, such an outward hip belt may comprise an adjustable fastening mechanism (e.g., a conventional belt buckle apparatus comprising a frame-and-prong element at one end of the belt and one or more prong-receiving through-openings at the other end of the belt) that allows the outward hip belt to be tightened to fit the girth of a particular user and fastened. (If a single hip belt is used, it may be adjustable/tightenable/fastenable in this manner.) With this understanding, it will be appreciated that as used herein, the expression “hip belt” means “at least one hip belt”, and specifically allows the presence of two belts, e.g. an inward hip belt and an outward hip belt, that are inserted through the belt guides in close proximity to each other. As noted, hip pad 1 may comprise at least one or more vent openings 8 that are not occluded by a hip belt or belts. Such arrangements, optionally in combination with the previously-discussed vent channels 9, can provide sufficient freedom for air circulation that the degree to which hip pad 1 might cause perspiration is reduced, even when e.g. a hip belt or belts, and hip pad 1, are tightly fastened about the user's hips.

In some embodiments, a hip belt (e.g., an outward hip belt) may be configured to support an optional tool receptacle that can accept and hold one or more utility tools (meaning any tool used for e.g. construction and/or industrial use and so on; e.g. a hammer, drill, saw, and so on). Such a tool receptacle can take any suitable form (e.g., a bag, an apron, and so on), as long as the tool receptacle does not interfere with the functioning of the safety harness as described below. In various embodiments, such a tool receptacle may be positioned along at least a portion of a front, left or right section of the hip belt.

Hip pad 1 is a component of a safety harness 200, portions of which are shown in exemplary representation in FIG. 8. By safety harness is meant any fall-protection (i.e., fall-arrest) harness that meets the requirements of ANSI/ASSE Z359.1-2007. In many embodiments, such a safety harness will meet the requirements of ANSI 10.32-2004, CSA Z259, OSHA 1910.66, and/or OSHA 1926.502. Such a fall-arrest safety harness may often comprise various torso straps and leg straps that collectively support the weight of the wearer of the safety harness in the event of a fall. Such straps may be adjustable so as to provide optimum fit for a wearer of harness 200. Portions of exemplary torso straps 229 and leg straps 223 are shown (for the right-hip area of harness 200; corresponding left-hip area components are omitted for clarity of presentation) in FIG. 8. (Also, the body of the user is omitted from FIG. 8, for ease of presentation.) It is emphasized that the arrangement shown in FIG. 8 is merely an exemplary representation; the ordinary artisan will appreciate that many strap configurations may be used as long as the above requirements are met.

Safety harness 200 may be used (in combination with e.g. one or more safety lines, self-retracting lifelines, or the like that is attached to the safety harness) for fall protection e.g. in areas such as construction and industrial activities (e.g. wind energy, oil/gas, mining and so on). Such a safety harness is worn by the user and moves with the user to allow the user to carry out work activities. The safety harness is configured to securely support the weight of the user's body (and to bear the forces involved in arresting the fall of a user) in the event that a fall causes the weight of the user to be borne by a safety line attached to the safety harness. Any suitable attachment mechanism may be provided to facilitate the connecting of safety harness 200 to one or more safety lines. For example, a dorsal D-ring (not shown in any Figure) may be provided to which may be attached e.g. a self-retracting lifeline. Additional D-rings may be provided at other locations for use in e.g. positioning the wearer. As noted, in particular embodiments, safety harness 200 may comprise inner and outer hip belts, with the inner belt comprising right and left termini (e.g. located respectively near the front of the right and left hips) each of which comprises a D-ring that may serve the dual purposes of providing an attachment point for positioning purposes, and of physically preventing the inner belt from being removed from (pulled through) the belt guides.

In the particular representative embodiment depicted in FIG. 8, torso straps 229 and leg straps 223, as well as hip belt 210, meet and cross over or under each other at right meeting area 250 proximate the right hip of the user. (A similar left meeting area would similarly exist proximate the user's left hip although not shown in FIG. 8.) Any of these straps and/or belts may be interlocked with each other (that is, so that one or more straps cannot be pulled out from the others) at such a meeting area. To facilitate such arrangements, in some embodiments one or more such straps or belts can comprise a “split” (not shown in any Figure) at such a meeting area. Such a split (which might be e.g. 5-10 cm long, along the long axis of the strap or belt) can be achieved e.g. by providing a strap or belt as a 2-ply construction, in which the two plies are joined (e.g. sewn) together along most of the length of the strap, except for a specified location (the split) at which the two plies are not joined to each other for a specified length and thus can be moved apart from each other at least e.g. a few centimeters. If one or more splits are provided in one or more straps and/or belts, certain portions of the straps and/or belts can be passed through one or more splits in other straps or belts so that the various straps and/or belts are interlocked with each other. While specific details are not shown in FIG. 8, it will be understood that any suitable combination of splits in any straps and/or belts can be used to this end. In designs in which an inner hip belt and an outer hip belt are used, in some embodiments an inner belt may comprise one or more splits so as to be interlocked with one or more of torso straps and/or leg straps, while an outer belt (which may be an adjustable/tightenable and fastenable belt) may be not interlocked, so that the outer belt can be removed from harness 200 if desired.

It is noted that the particular design shown in FIG. 8 is merely an arrangement which might be particularly suitable in some instances, and it is emphasized that any suitable interlocking and/or mechanical fastening mechanism, between any of the various straps and/or belts, may be used. In summary, in whatever manner desired, the various straps of safety harness 200 can be interlocked with each other so as to support the weight of the user in the event of a fall. As noted above, one or more hip belts 210 may also be interlocked with one or more of torso straps and/or leg straps if desired, although hip belt 210 may not be weight-bearing in the same manner as the torso and leg straps.

As mentioned, the design of a fall-arrest safety harness can vary. In particular, the presence, size, shape, specific location, etc., of various cushions (e.g., back cushions, shoulder cushions, chest cushions, thigh and/or gluteal cushions), as well as the location and type of buckles, which buckles are adjustable and which are not, which straps comprise a female buckle component and which comprise a male buckle component, the type and location of attachment mechanisms, and so on, can vary widely. All such variations are encompassed by the general term safety harness as used herein, as long as the above-listed requirements of such a fall-arrest safety harness are met.

### LIST OF EXEMPLARY EMBODIMENTS

Embodiment 1 is a hip pad configured to be fitted to a hip belt of a safety harness, the hip pad comprising: a sagittal portion comprising a sagittal portion belt guide fixed thereto, which sagittal portion belt guide is configured to accept a sagittal section of the hip belt therethrough and defines a sagittal portion belt orientation axis that, when the safety harness is worn by a user, is at least substantially parallel to a transverse plane of the user; a right portion that extends from a right end of the sagittal portion and that comprises a right portion belt guide fixed thereto, which right portion belt guide is configured to accept a right section of the hip belt therethrough and defines a right portion belt orientation axis that is at an upwardly offset angle from the sagittal portion belt orientation axis; and, a left portion that extends from a left end of the sagittal portion and that comprises a left portion belt guide fixed thereto, which left portion belt guide is configured to accept a left section of the hip belt therethrough and defines a left portion belt orientation axis that is at an upwardly offset angle from the sagittal portion belt orientation axis, wherein the upwardly offset angle of the left and right portion belt guides is from about ten to about twenty degrees.

Embodiment 2 is a hip pad of embodiment 1 wherein the right portion of the hip pad is a right elongate arm with a proximal end that integrally extends from a right end of the sagittal portion of the hip pad and with a distal end having the right belt guide fixed thereto, and wherein the left portion of the hip pad is a left elongate arm with a proximal end that integrally extends from a left end of the sagittal portion of the hip pad and with a distal end having the left belt guide fixed thereto. Embodiment 3 is a hip pad of embodiment 2 wherein the right elongate arm of the hip pad exhibits a long axis that is at least substantially aligned with the right portion belt orientation axis that is defined by the right portion belt guide, and wherein the left elongate arm of the hip pad exhibits a long axis that is at least substantially aligned with the left portion belt orientation axis that is defined by the left portion belt guide.

Embodiment 4 is a hip pad of any of embodiments 1-3 wherein the sagittal portion of the hip pad comprises: a central region; a right vented region that extends integrally from a right end of the central region and that comprises a left end that integrally abuts the right end of the central region of the sagittal portion and that comprises a right end that provides the right end of the sagittal portion of the hip pad, and, a left vented region that extends integrally from a left end of the central region and that comprises a right end that integrally abuts the left end of the central region of the sagittal portion and that comprises a left end that provides the left end of the sagittal portion of the hip pad, wherein the right and left vented regions of the sagittal portion of the hip pad each comprise at least one vent opening that extends through the hip pad and that is not occluded by the hip belt when the hip pad is fitted to the hip belt. Embodiment 5 is a hip pad of embodiment 4, wherein the right vented region tapers in generally vertical width so that a generally vertical width of the right end of the right vented region is less than a generally vertical width of the left end of the right vented region by at least about 20%, and, wherein the left vented region tapers in generally vertical width so that a generally vertical width of the left end of the left vented region is less than a generally vertical width of the right end of the left vented region by at least about 20%. Embodiment 6 is a hip pad of any of embodiments 4-5 wherein an inward side of the central region of the sagittal portion of the hip pad comprises a plurality of thermoformed vent channels that extend at least generally along a major plane of the central region of the hip pad, at least some of which vent channels are in fluid communication with an upper edge and/or a lower edge of the central region of the sagittal portion of the hip pad, and at least one of which vent channels is in fluid communication with at least one of the vent openings of the right vented region and/or at least one of the vent openings of the left vented region of the sagittal portion of the hip pad.

Embodiment 7 is a hip pad of any of embodiments 1-6 wherein the hip pad comprises a first core layer that is an integral layer of thermoformed resilient organic polymer foam and that integrally extends through the sagittal portion and the right and left portions of the hip pad. Embodiment 8 is a hip pad of embodiment 7 wherein the hip pad further comprises a second core layer that is positioned outward of the first core layer and is at least generally coterminous therewith, which second core layer is an integral layer of conformal organic polymer foam that integrally extends through the sagittal portion and the right and left portions of the hip pad and that comprises an inward-facing major surface that is adhesively bonded to an outward-facing major surface of the first core layer, wherein the second core layer comprises an average thickness that is no more than 20% of an average thickness of thickest areas of the first core layer, wherein a density of the organic polymer foam of the second core layer is greater than a density of the organic polymer foam of the first core layer by a factor of at least three, and wherein all uncompressed areas of the second core layer comprise a thickness that is at least about 80% of an unthermoformed thickness of the second core layer. Embodiment 9 is a hip pad of embodiment 8 further comprising: an inward surface layer that is a stretchable fabric that is positioned inwardly of the first core layer and that is thermoformed along therewith and that comprises a first major surface that is adhesively bonded to an inward-facing major surface of the first core layer and that comprises a second major surface that provides an inwardmost surface of the hip pad; and, an outward surface layer that is a non-stretchable fabric comprised of filaments of at least about 100 denier, and that is positioned outwardly of the second core layer and that comprises a first major surface that is adhesively bonded to an outward-facing major surface of the second core layer and that comprises a second major surface that provides at least a portion of an outwardmost surface of the hip pad.

Embodiment 10 is a hip pad of any of embodiments 1-9 further comprising a molded flexible organic polymer protective plate that substantially outwardly covers a central region of the sagittal portion of a main body of the hip pad and that outwardly covers at least a portion of a right vented region and at least a portion of a left vented region of the main body of the hip pad. Embodiment 11 is a hip pad of embodiment 10 wherein the molded flexible organic polymer protective plate comprises a plurality of through-holes at least some of which at least generally align with a plurality of through-holes in at least a first core layer of the hip pad, which first core layer is an integral layer of thermoformed resilient organic polymer foam that integrally extends through the sagittal portion and the right and left portions of the hip pad, wherein the alignment of the through-holes of the protective plate and the through-holes of the first core layer provide a plurality of vent openings in the right vented region and in the left vented region of the hip pad.

Embodiment 12 is a hip pad of any of embodiments 1-11 wherein the sagittal portion belt guide, the right portion belt guide, and the left portion belt guide, each comprise a single rigid molded organic polymer piece that is attached to the hip pad by way of at least two rivets that each pass through the hip pad. Embodiment 13 is a hip pad of any of embodiments 1-12 wherein the sagittal portion belt guide, the right portion belt guide, and the left portion belt guide, are each comprised of a canvas material. Embodiment 14 is a fall-arrest safety harness comprising a hip belt that is fitted with the hip pad of any of embodiments 1-13. Embodiment 15 is a safety harness of embodiment 14 wherein the hip belt is configured to support at least one tool receptacle along at least a portion of a front, left or right section of the hip belt. Embodiment 16 is a safety harness of any of embodiments 14-15 wherein the hip pad is configured so that when the hip pad is fitted to the hip belt and the safety harness is worn by a user, the right and left portions of the hip pad respectively forwardly wrap at least partially around right and left hip areas of the user and an upper edge of the sagittal portion of the hip pad remains generally even with, or below, a transtubercular plane of the user.

It will be apparent to those skilled in the art that the specific exemplary elements, structures, features, details, configurations, etc., that are disclosed herein can be modified and/or combined in numerous embodiments. (In particular, any of the elements that are positively recited in this specification as alternatives, may be explicitly included in the claims or excluded from the claims, in any combination as desired.) All such variations and combinations are contemplated by the inventor as being within the bounds of the conceived invention not merely those representative designs that were chosen to serve as exemplary illustrations. Thus, the scope of the present invention should not be limited to the specific illustrative structures described herein, but rather extends at least to the structures described by the language of the claims, and the equivalents of those structures.

What is claimed is:

1. A hip pad configured to be fitted to a hip belt of a safety harness, the hip pad comprising:
a sagittal portion comprising a sagittal portion belt guide fixed thereto, which sagittal portion belt guide is configured to accept a sagittal section of the hip belt therethrough and defines a sagittal portion belt orientation axis that, when the safety harness is worn by a user, is at least substantially parallel to a transverse plane of the user;
a right portion that extends from a right end of the sagittal portion and that comprises a right portion belt guide fixed thereto, which right portion belt guide is configured to accept a right section of the hip belt therethrough and defines a right portion belt orientation axis that is at an upwardly offset angle from the sagittal portion belt orientation axis;
and,
a left portion that extends from a left end of the sagittal portion and that comprises a left portion belt guide fixed thereto, which left portion belt guide is configured to accept a left section of the hip belt therethrough and defines a left portion belt orientation axis that is at an upwardly offset angle from the sagittal portion belt orientation axis,
wherein the upwardly offset angle of the left and right portion belt guides is from about ten to about twenty degrees.

2. The hip pad of claim 1 wherein the right portion of the hip pad is a right elongate arm with a proximal end that integrally extends from a right end of the sagittal portion of the hip pad and with a distal end having the right belt guide fixed thereto, and wherein the left portion of the hip pad is a left elongate arm with a proximal end that integrally extends from a left end of the sagittal portion of the hip pad and with a distal end having the left belt guide fixed thereto.

3. The hip pad of claim 2 wherein the right elongate arm of the hip pad exhibits a long axis that is at least substantially aligned with the right portion belt orientation axis that is defined by the right portion belt guide, and wherein the left elongate arm of the hip pad exhibits a long axis that is at least substantially aligned with the left portion belt orientation axis that is defined by the left portion belt guide.

4. The hip pad of claim 1 wherein the sagittal portion of the hip pad comprises:
a central region;
a right vented region that extends integrally from a right end of the central region and that comprises a left end that integrally abuts the right end of the central region of the sagittal portion and that comprises a right end that provides the right end of the sagittal portion of the hip pad,
and,
a left vented region that extends integrally from a left end of the central region and that comprises a right end that integrally abuts the left end of the central region of the sagittal portion and that comprises a left end that provides the left end of the sagittal portion of the hip pad,
wherein the right and left vented regions of the sagittal portion of the hip pad each comprise at least one vent opening that extends through the hip pad and that is not occluded by the hip belt when the hip pad is fitted to the hip belt.

5. The hip pad of claim 4, wherein the right vented region tapers in generally vertical width so that a generally vertical width of the right end of the right vented region is less than a generally vertical width of the left end of the right vented region by at least about 20%,
and,
wherein the left vented region tapers in generally vertical width so that a generally vertical width of the left end of the left vented region is less than a generally vertical width of the right end of the left vented region by at least about 20%.

6. The hip pad of claim 4 wherein an inward side of the central region of the sagittal portion of the hip pad comprises a plurality of thermoformed vent channels that extend at least generally along a major plane of the central region of the hip pad, at least some of which vent channels are in fluid communication with an upper edge and/or a lower edge of the central region of the sagittal portion of the hip pad, and at least one of which vent channels is in fluid communication with at least one of the vent openings of the right vented region and/or at least one of the vent openings of the left vented region of the sagittal portion of the hip pad.

7. The hip pad of claim 1 wherein the hip pad comprises a first core layer that is an integral layer of thermoformed resilient organic polymer foam and that integrally extends through the sagittal portion and the right and left portions of the hip pad.

8. The hip pad of claim 7 wherein the hip pad further comprises a second core layer that is positioned outward of the first core layer and is at least generally coterminous therewith, which second core layer is an integral layer of conformal organic polymer foam that integrally extends through the sagittal portion and the right and left portions of the hip pad and that comprises an inward-facing major surface that is adhesively bonded to an outward-facing major surface of the first core layer,
wherein the second core layer comprises an average thickness that is no more than 20% of an average thickness of thickest areas of the first core layer,
wherein a density of the organic polymer foam of the second core layer is greater than a density of the organic polymer foam of the first core layer by a factor of at least three,
and wherein all uncompressed areas of the second core layer comprise a thickness that is at least about 80% of an unthermoformed thickness of the second core layer.

9. The hip pad of claim 8 further comprising:
an inward surface layer that is a stretchable fabric that is positioned inwardly of the first core layer and that is thermoformed along therewith and that comprises a first major surface that is adhesively bonded to an inward-facing major surface of the first core layer and that comprises a second major surface that provides an inwardmost surface of the hip pad;
and,
an outward surface layer that is a non-stretchable fabric comprised of filaments of at least about 100 denier, and that is positioned outwardly of the second core layer and that comprises a first major surface that is adhesively bonded to an outward-facing major surface of the second core layer and that comprises a second major surface that provides at least a portion of an outwardmost surface of the hip pad.

10. The hip pad of claim 1 further comprising a molded flexible organic polymer protective plate that substantially outwardly covers a central region of the sagittal portion of a main body of the hip pad and that outwardly covers at least a portion of a right vented region and at least a portion of a left vented region of the main body of the hip pad.

11. The hip pad of claim 10 wherein the molded flexible organic polymer protective plate comprises a plurality of through-holes at least some of which at least generally align with a plurality of through-holes in at least a first core layer of the hip pad, which first core layer is an integral layer of thermoformed resilient organic polymer foam that integrally extends through the sagittal portion and the right and left portions of the hip pad,
wherein the alignment of the through-holes of the protective plate and the through-holes of the first core layer provide a plurality of vent openings in the right vented region and in the left vented region of the hip pad.

12. The hip pad of claim 1 wherein the sagittal portion belt guide, the right portion belt guide, and the left portion belt guide, each comprise a single rigid molded organic polymer piece that is attached to the hip pad by way of at least two rivets that each pass through the hip pad.

13. The hip pad of claim 1 wherein the sagittal portion belt guide, the right portion belt guide, and the left portion belt guide, are each comprised of a canvas material.

14. A fall-arrest safety harness comprising a hip belt that is fitted with the hip pad of claim 1.

15. The safety harness of claim 14 wherein the hip belt is configured to support at least one tool receptacle along at least a portion of a front, left or right section of the hip belt.

16. The safety harness of claim 14 wherein the hip pad is configured so that when the hip pad is fitted to the hip belt and the safety harness is worn by a user, the right and left portions of the hip pad respectively forwardly wrap at least partially around right and left hip areas of the user and an upper edge of the sagittal portion of the hip pad remains generally even with, or below, a transtubercular plane of the user.
